(19) United States
(12) Patent Application Publication
(10) Pub. No.: US 2014/0368789 A1
(43) Pub. Date: Dec. 18, 2014

(54) METHOD AND APPARATUS FOR MODULATING PRISM AND CURVATURE CHANGE OF REFRACTIVE INTERFACES

(71) Applicant: Garth T. WEBB, Surrey (CA)

(72) Inventor: Garth T. Webb, Surrey (CA)

(21) Appl. No.: 14/378,928

(22) PCT Filed: Feb. 20, 2013
(86) PCT No.: PCT/CA2013/000155

§ 371 Date: Aug. 14, 2014

Related U.S. Application Data
(60) Provisional application No. 61/604,608, filed on Feb. 29, 2012.

(51) Int. Cl. G02B 3/14; G02C 7/08

(52) U.S. Cl. CPC G02B 3/14; G02C 7/085
USPC 351/159.68; 359/666

(57) ABSTRACT

An adaptive lens system comprises i) a lens compartment with a transparent cover; ii) a deformable transparent optical element mounted in the lens compartment which forms a sealed upper chamber in the lens compartment between the transparent cover and the upper surface of the optical element, and also defining a lower region external to the lower surface of the optical element; iii) a first transparent fluid medium in the upper chamber and a second transparent fluid medium in the lower region, the first and second fluid media having different refractive indices; iv) a structural element located in and movable in the upper chamber relative to the deformable optical element to mechanically engage the deformable optical element to thereby alter the curvature of the deformable optical element, thereby altering the refractive power or the prismatic effect of the adaptive lens system.

### CROSS REFERENCE TO RELATED APPLICATION

The present application claims the benefits, under 35 U.S.C.§119(e), of U.S. Provisional Application Ser. No. 61/604,608 filed Feb. 29, 2012 entitled “Method and Apparatus for Modulating Prism and Curvature Change of Refractive Interfaces” which is incorporated herein by this reference.

### TECHNICAL FIELD

The invention relates to the field of adaptive lenses, and in particular adaptive lenses that change refractive power by altering their shape.

### BACKGROUND

Adaptive lenses are lenses that change refractive power either by altering curvature or refractive index. Adaptive lenses present several advantages over conventional fixed focus lens systems. Perhaps the most important of these is their ability to change focus without shifting the position of their nodal point. Another advantage is the speed whereby an adaptive lens may shift focus. Often, adaptive lenses require less energy to alter focus than fixed focus lens systems. Another important attribute of adaptive lenses is that they can operate within compact spaces. These features are essential requirements for use within biological systems such as the human eye but they are also important for certain camera and optical instrument applications. Adaptive lenses may be used to restore perfect visual function within the human eye; likewise, they may be used in optical devices to replicate the human visual experience.

Various artificial adaptive lens types have been designed. One type, marketed under the trademark Holochip, involves hydraulic force to change curvature by squeezing liquid within a confined space causing an elastomeric optical membrane to distend or bulge forward to increase the curvature its liquid refractive medium. See U.S. Pat. Nos. 7,755,840 and 8,064,142. Various mechanisms such as piezoelectronics are used to displace the liquid which actuates this curvature change. Elastic properties of the elastomeric optical membrane return the adaptive lens back to its rest position. Such lens designs provide a solution for altering the curvature of an optical interface, but have a number of practical limitations such as material fatigue, temperature instability and poor optical quality.

Other examples of adaptive lens technology may be found in the arena of accommodating intraocular lenses. Many attempts to modulate curvature change within the confines of the lens compartment of the human eye are recorded. Most designs, like the Holochip lens, operate by distending low modulus or elastic optical membranes with hydraulic pressure. In reality, delicate structures within the eye cannot generate enough force to induce curvature change by this mechanism.

The present applicant has disclosed in United States

Provisional Patent application No. 61/514,746, filed Aug. 3, 2011 and entitled INFLATABLE LENS, which is incorporated herein by reference, a variable focus lens in which a negative partial pressure is created within a sealed fluid filled lens. The negative partial pressure is sufficient to collapse a deformable optical interface against the surface of an internal support structure. The force required to revert the deformable optical interface back to its original shape is nominal and is measured in milligrams. It is well within the range of force generated by muscles within the eye. This adaptive lens technology is amenable to camera and instrument applications but it is composed of delicate structures that function best within temperature controlled environments such as that within the human eye. The present inventor has also disclosed in Patent Cooperation Treaty Patent Application No. PCT/CA2008/001456, publication no. WO2009/021327, filed 12 Aug. 2008 entitled INFLATABLE INTRA OCULAR LENS/LENS RETAINER, which is incorporated herein by reference, the use optical springs and sculpted optical interfaces to modulate optically cohesive curvature changes for high resolution optics throughout a wide range of curvature change.

New industrial and consumer applications are emerging rapidly for adaptive lenses. Many of these expose optical components to stresses such as temperature change, pressure variability, impact and chemical exposure. An adaptive lens system that operates well while subject to these and other stresses is required. There is therefore a need for an improved adaptive lens system.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention provides an adaptive lens system having a deformable optical element that separates two transparent fluid media having different refractive indices, wherein said deformable optical element is engaged by a mobile structural element to mechanically alter the curvature or the shape of said deformable optical element, thereby altering the refractive power or the prismatic effect of the adaptive lens.

More particularly, the invention provides an adaptive lens system comprising: i) a lens compartment comprising a transparent cover; ii) a deformable transparent optical element mounted in the lens compartment, the optical element comprising an upper surface and a lower surface and thereby forming a sealed upper chamber in the lens compartment between the transparent cover and at least a portion of the upper surface, and also defining a lower region external to the lower surface; iii) a first transparent fluid medium in the upper chamber and a second transparent fluid medium in the lower region, the first and second fluid media having different refractive indices; iv) a structural element located in and movable in said upper chamber relative to the deformable optical element to mechanically engage the deformable optical element to thereby alter the curvature of the deformable optical element, thereby altering the refractive power or the prismatic effect of the adaptive lens system.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a vertical cross sectional view of a first embodiment of the invention in its resting state.

FIG. 2 is a vertical cross sectional view of the embodiment shown in FIG. 1 in its compressed state.

FIG. 3 is a vertical cross sectional view of a second embodiment in its resting state.

FIG. 4 is a vertical cross sectional view of the embodiment shown in FIG. 3 in its compressed state.

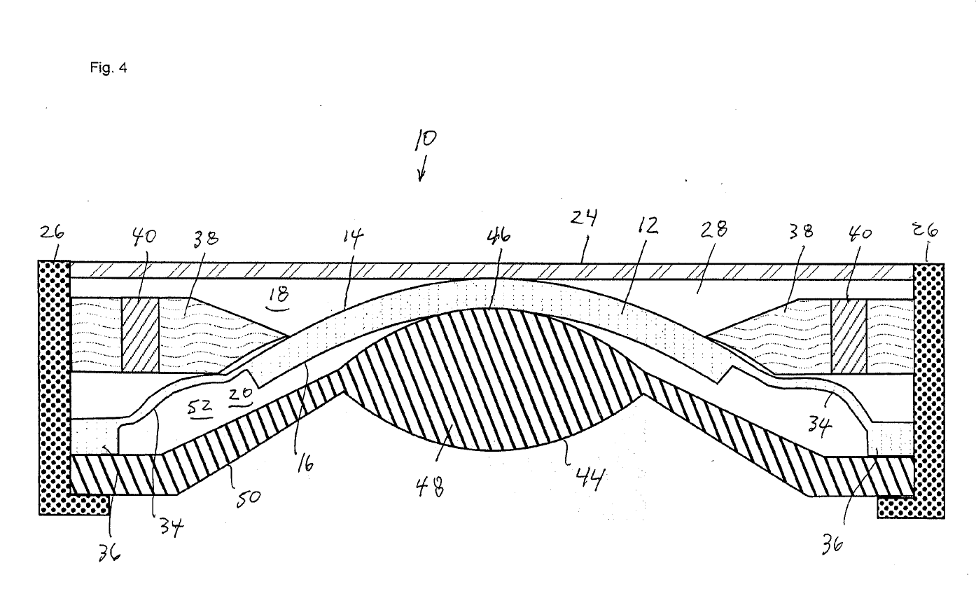

FIG. 5 is a plan view of the deformable optical element.

FIG. 6 is a plan view of the mobile structural element.

FIG. 7 is an elevation view of a class two lever arm with adaptive lens.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

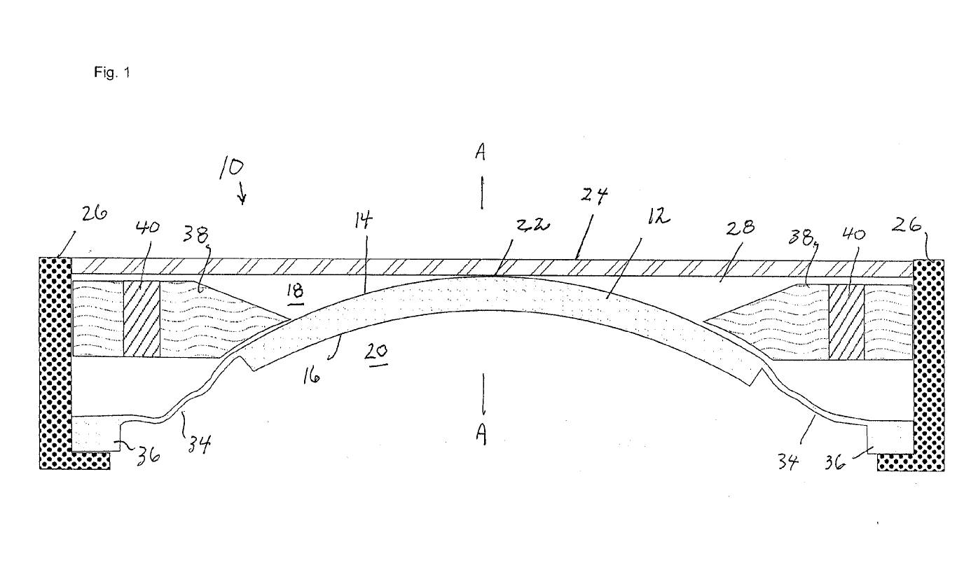

The present invention comprises an adaptive lens system 10 (shown in vertical cross-section and which is generally symmetric about the central axis A-A). It incorporates a deformable optical element 12 whose optical surfaces 14, 16 are in contact with a first fluid optical medium 18 on one side and a second fluid optical medium on its other side 20. FIG. 1 shows a first embodiment of the invention wherein deformable optical element 12 is firmly attached at its apex 22 to lid cover 24. Lid cover 24 is an optically transparent circular disc that is attached around its circumference to circular wall 26 to form hollow lens compartment 28. The bottom of hollow lens compartment 28 is defined by deformable optical element 12. The cross sectional profile of deformable optical element 12 may be flat, concave, convex or any combination of these.

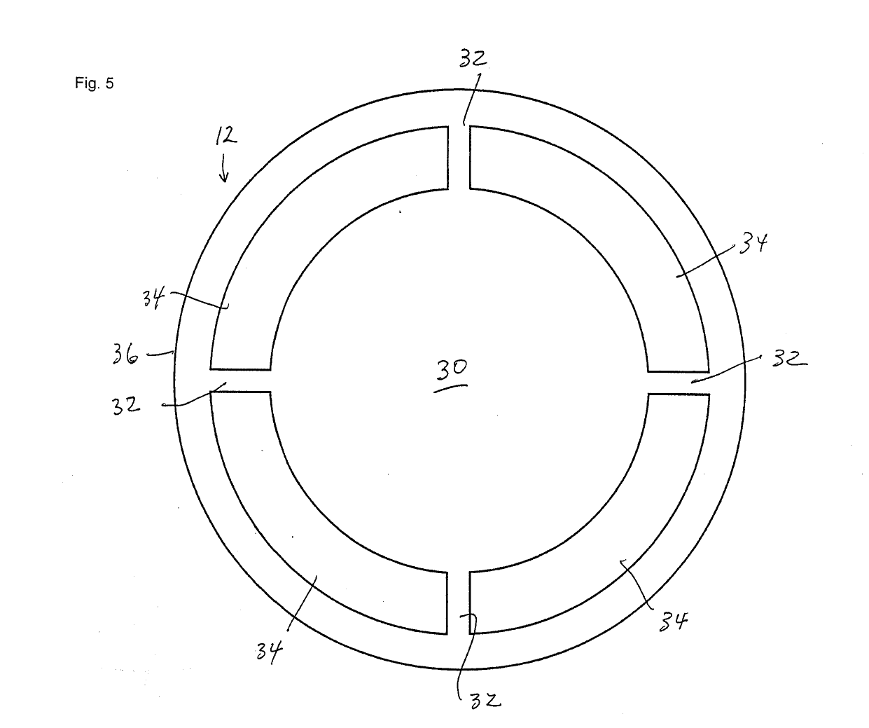

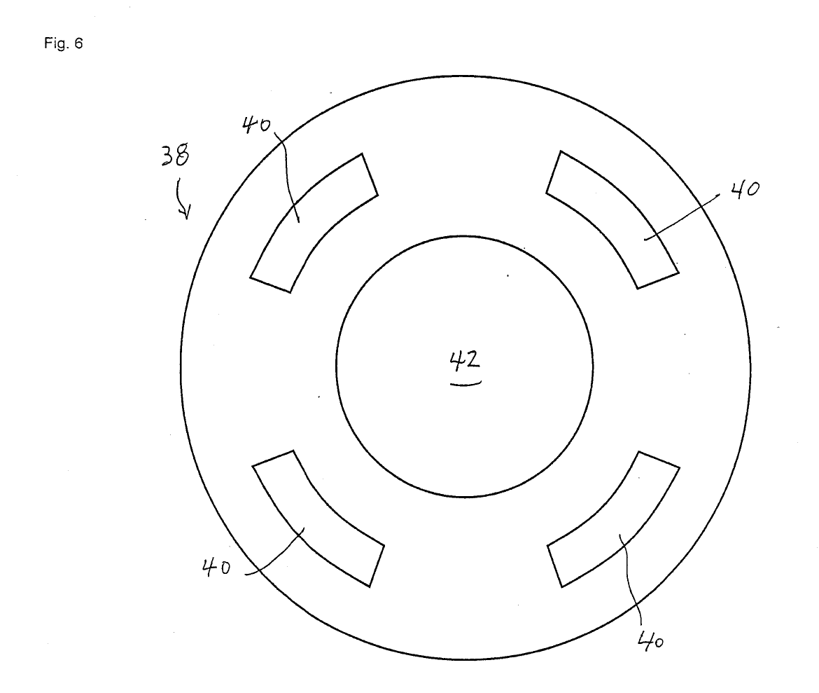

FIG. 5 shows a plan view of the deformable optical element 12 wherein the central optical zone is suspended around its perimeter by radial spokes 32 and flexible membranes 34. The outermost perimeter of the deformable optical element comprises circular seal 36 which is attached to circular wall 26 of the resultant sealed lens compartment. Mobile structural element 38 is shown in FIG. 1 within the sealed lens compartment 28 and is immersed within first fluid medium 18. Mobile structural element 38 is an annulus that has vents 40 that run concentrically through the annulus. Mobile structural element 38 is not attached to circular wall 26. It is free to travel in a direction parallel to optical axis A-A of the refractive system 10. FIG. 6 shows a plan view of mobile structural element structure 38 having central opening 42 and vents 40 which allow for flow of first liquid medium 18 throughout the sealed lens compartment as mobile structural element 38 slides along optical axis A-A. Second fluid medium 20 is displaced when mobile structural element 38 presses against deformable optical element 12.

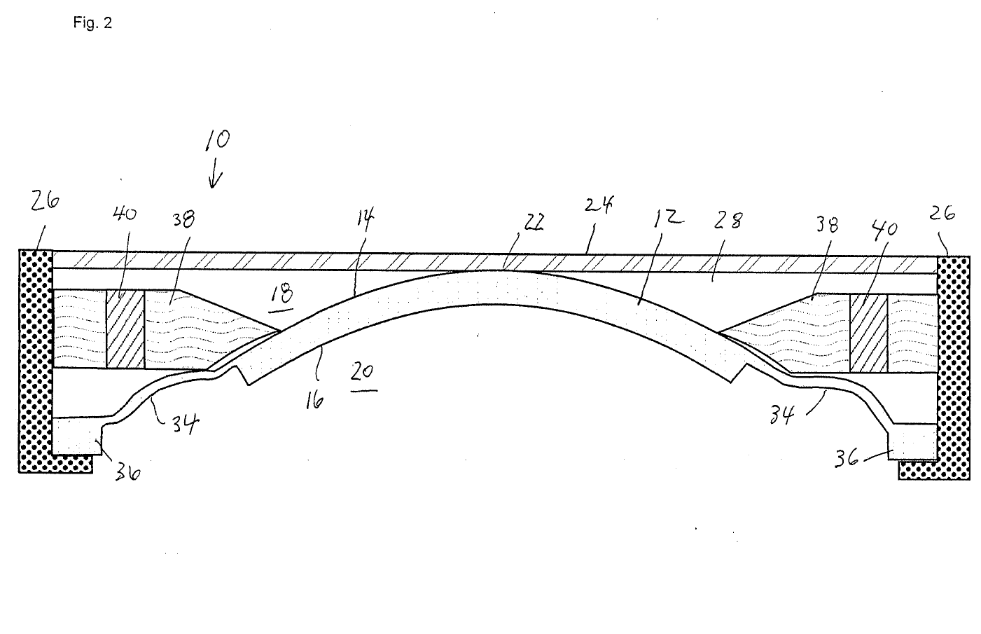

In operation, mobile structural element 38 slides toward the bottom of hollow lens compartment 28 as shown in FIG. 2. The central region of deformable optical element 12 remains attached to lid cover 24 while peripheral regions of deformable optical element 12 are compressed and shifted toward the bottom of hollow lens compartment 28, resulting in an increased curvature of deformable optical element 12, as shown. The curvature of the first surface 14 of deformable optical element 12 increases in convexity. The curvature of the second surface 16 increases in concavity. When the refractive index of the two fluid media 18, 20 are sufficiently different, the refractive properties of the refractive system changes. When the refractive index of first fluid media 18 is greater than second fluid media 20, light entering the refractive system 10 will become more divergent. When the refractive index of the first fluid media 18 is less that second fluid media 20, light entering the refractive system 10 will become more convergent. A vacuum may serve as a fluid optical medium 18 with a refractive index of 1.0. For purposes of this disclosure, “fluid medium” therefore includes a vacuum.

FIG. 2 shows flexible membranes 34 distending toward lens cover 24 in response to a partial vacuum created within the hollow lens compartment 28 when peripheral regions of deformable optical element 12 are compressed and shifted. Distension of flexible membranes 34 causes fluid within hollow lens compartment 28 to circulate. Vents 40 allow fluid to circulate toward lid cover 24 to fill the void left by the movement of mobile structural element 38.

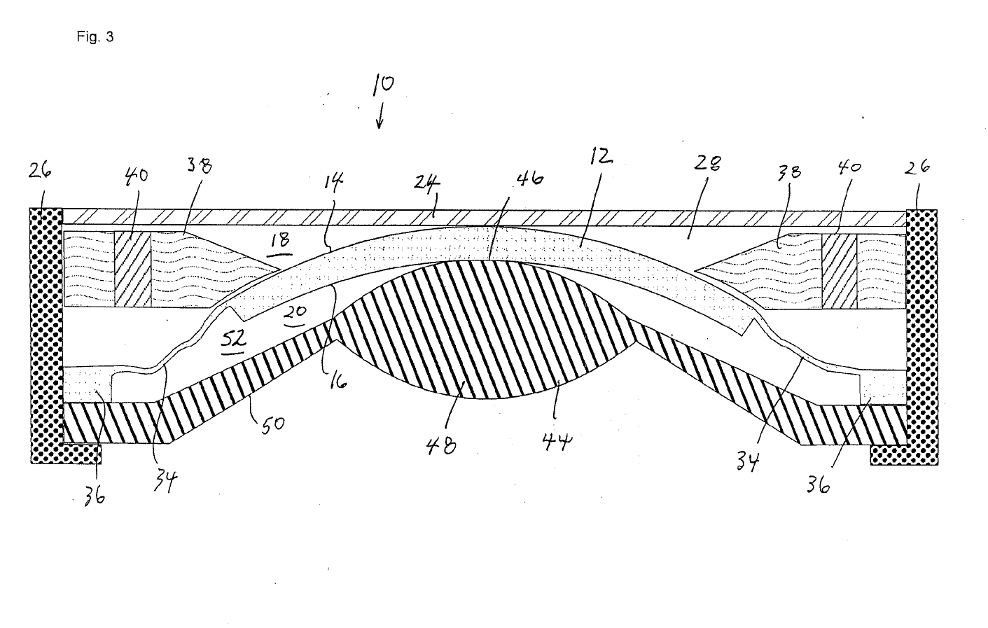

FIG. 3 shows a cross section of a second embodiment that comprises the same apparatus as shown in FIG. 1 except for the addition of opposing support structure 44. Deformable optical element 12 is pressed against the apex 46 of opposing located support structure 44. In this situation, it is not necessary for deformable optical element 12 to be adhered to lid cover 24.

Opposing located support structure 44 is preferably a disc shaped rigid lens that comprises central optic 48 and haptic 50. Second fluid compartment 52 is created by the space between deformable optical element 12 and centrally located support structure 44. A closed system incorporating two fluid media, one on each side of deformable optical element 12, each within a sealed compartment is thus defined. Fluid dynamics within a closed environment are more efficient than open systems such as that shown in FIG. 1. They are also much more convenient for use within portable optical systems.

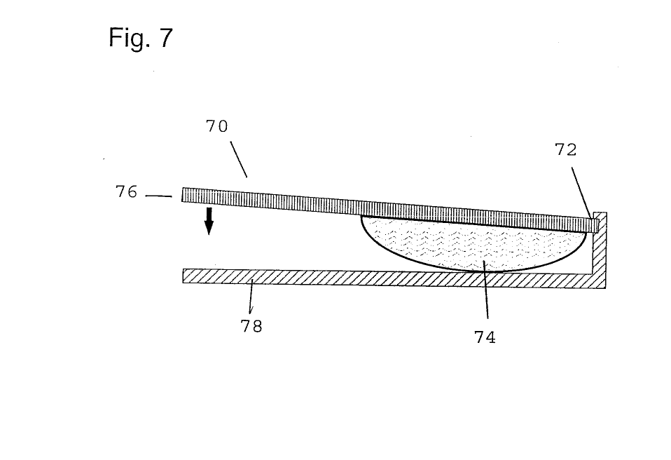

Movement causing curvature change of deformable optical element 12 may be generated by change of location of either mobile structural element 38 or opposing located support structure 44 or deformable optical element 12. Movement of these structures may generate symmetric curvature change or asymmetric change, such as that required to produce prism along with curvature change. Movement of these structures may be actuated by any externally generated force such as electromagnetic fields, piezoelectronic transducers or mechanical lever force (see FIG. 7). Elements required to actuate shape change may be contained within the hollow lens compartment or outside it.

Prism may be induced by selectively restricting the movement of mobile structural element 38 with either a hinge (FIG. 7) or a buttress (not shown). The hinge prevents one side of mobile structural element 38 from travelling parallel to the optical axis A-A and yet allows the opposite side to move. The result is a tilting effect which tilts deformable optical element 12 thereby inducing the same tilt of the interface of the fluid media, thereby introducing prism. Prism may be distributed uniformly across the optical zone of deformable optical element 12, provided that there is no adhesion between the apex of deformable optical element 12 and lid cover 24.

Prism may be used to advantage with binocular optical systems such as three dimensional cameras, especially if it is modulated by the same system that controls the focusing mechanism. Optical images that are properly formatted for the human visual system are converted into digital information accurately and without the time delay normally encountered with software systems that interpret and re-configure visual images. Opposing support structure 44 may incorporate the negatively pressurized inflatable lens of U.S. Provisional Patent application 61/514,746 to combine the ability of the present invention to modulate prism with the ability of the negatively pressurized inflatable lens to change focus, in a variety of ways, to simulate the full-field, three dimensional human visual experience at any distance.

Within the human eye, restriction of movement of mobile structural element 38, with the use of a hinge, provides two mechanical advantages over circumferentially uniform designs that have commonly appeared in adaptive intraocular lens designs. In FIG. 7, lever arm 70 is restrained at one end by hinge 72, thus creating a class two lever arm with adaptive lens 74 serving as the ‘load’, and the free-end 76 serving as the lever arm for the force vector, as shown. In the eye, force is supplied by traction upon the lens capsule by the ciliary muscles, which presses lever arm 70 and stationary arm 78 together, thereby compressing adaptive lens 74. To apply the lever shown in FIG. 7 to movement of the mobile structural element 38, mobile structural element 38 forms the lever arm 70. Due to the conformity of the refractive media on both sides of mobile structural element 38, prismatic effect generated is nominal; however, mechanical force exerted by ciliary muscle action upon the adaptive lens 74 is amplified by the effect of the class two lever arm thus created. Another advantage of employing a class two lever system relates to the ability to reduce the bulk of movable parts within a small incision of the lens capsule of the eye during lens replacement procedures.

The class two lever arrangement 70 shown in FIG. 7 can be used to move the structural element 38 within the lens compartment 28 of adaptive lens system 10, or the lever arrangement 70 can function independently in conjunction with adaptive lens 74 to form the intraocular adaptive lens system in which mechanical force exerted by ciliary muscle action causes deformation of lens 74.

The invention works within an open system as shown in FIG. 1 or a self-contained closed system as shown in FIG. 3. Displaced liquid may vent into open space or expandable compartments such as a syringes and deformable containers or it may displace axially along the optical axis A-A to alter the shape or position of a secondary optical element (not shown). Preferably central support structure 44 is a convex shape. Alternatively, it may be any shape so long as it is immersed within an index matched fluid medium and peripheral regions of deformable optical element 12 are free to respond to mechanical force. This apparatus may be used to focus electromagnetic waves of any frequency but may also be used to focus ultrasound energy.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within their true spirit and scope.

What is claimed is:

1. An adaptive lens system comprising:
i) a lens compartment comprising a transparent cover;
ii) a deformable transparent optical element mounted in said lens compartment, said optical element comprising an upper surface and a lower surface and thereby forming a sealed upper chamber in said lens compartment between said transparent cover and at least a portion of said upper surface, and also defining a lower region external to said lower surface;
iii) a first transparent fluid medium in said upper chamber and a second transparent fluid medium in said lower region, said first and second fluid media having different refractive indices;
iv) a structural element located in and movable in said upper chamber relative to said deformable optical element to mechanically engage said deformable optical element to thereby alter the curvature of said deformable optical element, thereby altering the refractive power or the prismatic effect of said an adaptive lens system.

2. The adaptive lens system of claim 1 wherein said structural element comprises an annular disc comprising in the area of the inner edge thereof a surface engageable with said upper surface of said deformable transparent optical element

3. The adaptive lens system of claim 1 wherein said structural element is movable by piezoelectric means.

4. The adaptive lens system of claim 1 wherein said structural element is movable by electromagnetic fields.

5. The adaptive lens system of claim 1 wherein one end of said structural element is hingedly secured relative to said deformable optical element and the other end of said structural element moves freely and whereby force applied to said free end of said structural element moves said free end of said structural element, thereby compressing said deformable transparent optical element.

6. The adaptive lens system of claim 1 wherein said structural element Vents 40 allow fluid to circulate toward lid cover 24 to fill the void left by the movement of mobile structural element

7. The adaptive lens system of claim 1 wherein said deformable transparent optical element is mounted in said lens compartment by being attached to said lens compartment by a flexible outer edge.

8. The adaptive lens system of claim 1 wherein said the upper surface of said deformable optical element is attached at its apex to said transparent cover.

9. The adaptive lens system of claim 1 further comprising an opposed support element located below said lower region and comprising a disc shaped rigid transparent lens forming with said deformable optical element a second sealed chamber in said lower region.

10. A method of controlling the focus of a lens by providing an adaptive lens system comprising a deformable optical element separating two transparent fluid media having different refractive indices, and altering the curvature of said deformable optical element by moving a structural element in contact with said deformable optical element, thereby altering the refractive power or the prismatic effect of said deformable optical element.

11. A method of providing accommodation with an aphacic eye by providing within the lens capsule of said aphacic eye an adaptive lens system comprising a deformable optical element separating two transparent fluid media having different refractive indices, and altering the curvature of said deformable optical element by moving a structural element in contact with said deformable optical element, thereby altering the refractive power or the prismatic effect of said deformable optical element.

12. The method of claim 10 or 11 wherein said structural element comprises an annular disc comprising in the area of the inner edge thereof a surface engageable with said upper surface of said deformable transparent optical element

13. The method of claim 10 or 11 wherein said structural element is movable by piezoelectric means.

14. The method of claim 10 or 11 wherein said structural element is movable by electromagnetic fields.

15. The method of claims 11 wherein one end of said structural element is hingedly secured relative to said deformable optical element whereby force supplied by traction upon the lens capsule by ciliary muscles moves said structural element, thereby compressing said deformable transparent optical element.

16. An adaptive lens system for location within the lens capsule of an aphacic eye, comprising:
i) a first lever arm having a first free end and a second end;
ii) a second lever arm having a first free end and a second end hingedly connected to the second end of the first lever arm;
iii) a deformable transparent optical element located between said first and second lever arms;
whereby force supplied by traction upon the lens capsule by ciliary muscles moves said first and second lever arms together, thereby compressing said deformable transparent optical element.
